(19) United States
(12) Patent Application Publication
(10) Pub. No.: US 2008/0233333 A1
(43) Pub. Date: Sep. 25, 2008

(54) FIBROUS PRODUCTS HAVING REDUCED FORMALDEHYDE EMISSIONS

(75) Inventors: Kim Tutin, East Point, GA (US); Kurt Gabrielson, Lilburn, GA (US); Robert W. Fleming, Alpharetta, GA (US)

Correspondence Address: PATENT GROUP GA30-43;GEORGIA-PACIFIC LLC, 133 PEACHTREE STREET, NE, ATLANTA, GA, 30303, US

(73) Assignee: Georgia-Pacific Chemicals LLC, Atlanta, GA (US)

(21) Appl. No.: 11/688,892

(22) Filed: Mar. 21, 2007

(51) Int. Cl. B32B 3/14

(52) U.S. Cl. 428/74

(57) ABSTRACT

A method for reducing formaldehyde emission from a fibrous product prepared using a binder based on a formaldehyde-containing resin, the method comprising isolating the fibrous product in an enclosed space, introducing a gaseous formaldehyde scavenger into the space and maintaining the gaseous scavenger in the space for a time sufficient to reduce the level of formaldehyde emission, with the result that the fibrous product exhibits a reduced level of formaldehyde emissions.

### FIELD OF THE INVENTION

The present invention relates to a method for reducing the level of formaldehyde emissions in fibrous products made using a formaldehyde-containing resin and especially for reducing the level of formaldehyde emissions in fiberglass insulation products, and to the packaged products resulting therefrom.

### BACKGROUND OF THE INVENTION

Formaldehyde-based resins or formaldehyde-containing resins, such as urea-formaldehyde (UF) resins, phenol-formaldehyde (PF) resins, including PF resins extended with urea (PFU) and melamine-formaldehyde (MF) resins find widespread use as adhesives and bonding agents for making a wide variety of products.

Thin glass mats are often made using a UF resin as the adhesive binder and are used in a variety of application such as a substrate for roofing shingles and as a facer for a variety of board products including gypsum boards.

Phenol-formaldehyde (PF) resins, as well as PF resins extended with urea (PFU resins), in particular, have been the mainstays of fiberglass insulation hinder technology over the past several years. Such resins are relatively inexpensive and provide the cured fiberglass insulation product with excellent physical properties.

Fiberglass insulation, often used in an uncompressed mat or blanket form or in a loosefill form, provides heat and sound insulation for roof and wall structures in residential and commercial buildings, and is used in a compressed form as insulation for pipes and other conduits, and also is used in a variety of other molded forms.

Such fiberglass insulation products are easy to install and provide an economical and effective insulating barrier to deaden sound and reduce heat loss through the roof and wall structures of buildings and through the surface of pipes and other conduits or containers used to contain hot or cold fluids and other materials.

For example, fiberglass insulation generally is shipped in a compressed form encased in plastic packaging to facilitate transportation and reduce costs. When the compressed bundles of fiberglass are used at a job site, it is important that the compressed fiberglass product recover a substantially amount of its pre-compressed thickness. If not the product will suffer a decrease is its thermal insulation and sound attenuation properties. Fiberglass insulation made with PF and PFU resins generally is able to recover most of its pre-compressed thickness, thus contributing to the wide acceptance of these resins in this application.

Fiberglass insulation suppliers, such as Guardian and Owens-Corning, also make fiber glass loosefill insulation products. One particular product is marketed by Guardian as Supercube 11®. Another product is marketed by Owens-Corning under the name Advanced ThermaCube Plus®. Such products also can be made using a PF or PFU resin adhesive. To make loosefill insulation products, including these products, fiberglass mats or blankets can be ground or “cubed” into smaller pieces. The insulation (also referred to as blowing wool) can also be packaged in a compressed form encased in a plastic wrapping to facilitate transportation and reduce costs. The loosefill insulation, such as in the form of “cubes,” facilitates installation into hard-to-reach areas and under conditions where there is limited space for human egress. The discrete insulation “cubes” are able to efficiently fill nooks and crevices to provide complete insulation coverage.

One of the perceived drawbacks of such fibrous products, including fiberglass insulation products, made using formaldehyde-based adhesive technology is their potential for formaldehyde emissions during handling, installation and subsequent use.

Producing a fibrous product having a reduced tendency to emit formaldehyde thus, remains a goal of manufacturers producing fibrous products bonded with formaldehyde-containing resins. There is a continuing need for new methods for reducing the formaldehyde emission from fibrous products, such as fiberglass insulation, made using formaldehyde-containing resin binders.

### BRIEF DESCRIPTION OF THE DRAWINGS

FIG. 1 schematically illustrates one embodiment of the method of the present invention for treating a fiberglass insulation product to reduce its tendency to emit formaldehyde.

### DETAILED DESCRIPTION OF THE INVENTION

The present invention is directed to a method for reducing the tendency of a fibrous product made using a formaldehyde-containing resin binder, such as a fiberglass insulation product, to emit formaldehyde. The invention also is directed to the resulting packaged fibrous product that has a reduced tendency to emit formaldehyde, such as a packaged fiberglass insulation product.

As used herein, the phrase “formaldehyde-containing resin,” means a resinous, thermosetting composition made from a molar excess of formaldehyde and one or more formaldehyde-reactive monomers such as phenol, urea, acetone, melamine and the like. Such resins typically contain free, i.e., unreacted formaldehyde, and exhibit formaldehyde emissions during their cure and in the absence of an effective treatment, following their cure. Such resins are well known to those skilled in the art and do not require a detailed description. Such resins are commercially available from many resin suppliers such as Georgia-Pacific Chemical LLC, Atlanta, Ga. The specific nature of the formaldehyde-containing resin does not form a part of the present invention.

One formaldehyde-containing resin commonly used in connection with the manufacture of fiberglass insulation is made by reacting a molar excess of formaldehyde with phenol in the presence of an alkaline catalyst such as sodium hydroxide. Before this resin is used, it is commonly premixed with urea and the urea is allowed to react with residual formaldehyde, such as for 4-16 hours, to form what is often referred to as a “prereact” before the adhesive binder is prepared for making the fiberglass insulation. After the prereaction, the binder often is made by adding water, ammonium sulfate, dedusting oils, ammonium hydroxide, dye, etc.

As used herein, “curing,” “cured” and similar terms are intended to embrace the structural and/or morphological change which occurs to an aqueous binder comprising a formaldehyde-containing resin, such as, for example, by covalent chemical reaction (crosslinking), ionic interaction or clustering, improved adhesion to the substrate, phase transformation or inversion, and hydrogen bonding when the resin is dried and heated to an infusible condition causing the properties of a flexible, porous substrate, such as a mat or blanket of glass fibers to which an effective amount of the binder has been applied, to be altered.

The term “cured binder” means the cured formaldehyde-containing resin which bonds the fibers of a fibrous product together. Generally, the bonding occurs at the intersection of overlapping fibers.

By “reduced tendency to emit formaldehyde” and related phrases are meant that a fibrous product, such as a fibrous mat, fibrous batt or loosefill fibrous pieces treated in accordance with the method of the present invention, exhibits a lower level of formaldehyde emission than the product would have exhibited if made with the same binder but in the absence of the formaldehyde scavenging method of the present invention.

As used herein the terms “fiber,” “fibrous” and the like are intended to embrace materials that have an elongated morphology exhibiting an aspect ratio (length to thickness) of greater than 100, generally greater than 500, and often greater than 1000.

As used herein the term “fibrous product” is intended to include porous products made by bonding fibers together with an adhesive binder prepared using a formaldehyde-containing resin. Usually such fibrous products, whether in an uncompressed or in a compressed form, have a density of less than 300 Kg/m³. More often such products have a density of less than 200 Kg/m³. The method of the present invention is particularly useful for treating a packaged fibrous product having a density of less than 160 Kg/m³. The method of the invention has been shown to work especially well with products having a density of less than 120 Kg/m³. Such fibrous products may be made from continuous fibers by swirling the endless filaments or strands of continuous fibers. Alternatively, the fibers may be chopped or cut to shorter lengths, or the fibers may be produced directly as short discontinuous fibers for mat, batt or blanket formation using techniques well known to those skilled in the art. Such techniques, though well known to skilled workers, form no part of the present invention. Use can also be made of ultra-fine fibers formed by the attenuation of glass rods. In addition to fibrous products made in the form of mats, batts and blankets, mention also can be made of other fibrous products such as duct board insulation and other molded insulation products. All of these fibrous products are characterized by having an internal, generally open porosity that harbors pockets of air that contributes to their acoustic and heat insulation capability. In such products, an amount of binder generally is applied sufficient only to fix the position of each fiber in the mat by bonding fibers where they cross or overlap and not to significantly interfere with the porosity of the product. Using binders with good flow characteristics allows the binder to flow to these fiber intersections. Thus, the binder composition is generally applied in the preparation of these fibrous products in an amount such that the cured binder constitutes about 1% to about 20% by weight, more usually about 3 to 12% by weight of the finished fibrous product.

As used herein the term “heat resistant fibers” is intended to embrace fibers suitable for withstanding elevated temperatures such as mineral fibers (e.g., basaltic fibers), aramid fibers, ceramic fibers, metal fibers, carbon fibers, polyimide fibers, certain polyester fibers, rayon fibers, and especially glass fibers. Such fibers are substantially unaffected by exposure to temperatures above about 120° C.

As used throughout the specification and claims, the terms “mat,” “batt” and “blanket” are used somewhat interchangeably to embrace a variety of fibrous substrates of a range of thicknesses and densities, made by entangling short fibers, long continuous fibers and mixtures thereof. It also is known that these mats, batts, or blankets can be cubed or ground to produce related loosefill, blowing wool insulation products (one such loosefill insulation product is marketed by Guardian under the product name Supercube II® and another under the name Advanced ThermaCube Plus® blowing wool product by Owens-Corning). Particularly preferred are mats, batts, blankets and loose fill-type products made using heat resistant fibers and especially glass fibers.

In a first aspect, the present invention is directed to a method for reducing the level of formaldehyde emission from a fibrous product which comprises isolating the fibrous product in an enclosed space, injecting into the enclosed space a gaseous formaldehyde scavenger and maintaining the scavenger in the enclosed space for a time sufficient to reduce the level of formaldehyde emission. The gaseous formaldehyde scavenger and the fibrous product can be introduced into the enclosed space in either order.

In another aspect, the present invention is directed to a method for reducing the level of formaldehyde emission from a fibrous product which comprises surrounding or encasing the fibrous product with a film, e.g., by wrapping the fibrous product with a film such as a plastic film, and providing a gaseous formaldehyde scavenger in the so-enclosed space in contact with the fibrous product for a time sufficient to reduce the level of formaldehyde emission.

In still another aspect, the present invention is directed to a method for reducing the level of formaldehyde emission from a fibrous product which comprises placing the fibrous product into a bag, such as a plastic bag, sealing the bag and injecting a gaseous formaldehyde scavenger into the sealed bag in contact with the fibrous product for a time sufficient to reduce the level of formaldehyde emission.

These and other aspects of the present invention will be described in the following specification with reference to specific embodiments. This application is not intended to be limited to these specific embodiments; but is intended to cover changes and substitutions that may be made by those skilled in the art without departing from the spirit and the scope of the invention as described further hereinafter.

As noted above, the present invention is directed to a method for treating a fibrous product, especially a fiberglass insulation product, to reduce the tendency of the fibrous product to emit formaldehyde. Such fibrous products have fibers bonded to one another with a crosslinked (cured) binder obtained by curing a curable adhesive binder comprising a formaldehyde-containing resin.

Applicant has found that by placing a gaseous formaldehyde scavenger in an enclosed space with the fibrous product one surprisingly obtains a very efficient reduction in the tendency of the fibrous product to emit formaldehyde. Indeed, applicant has found that the gaseous formaldehyde scavenger is so efficient in reducing the level of formaldehyde emissions from the fibrous product that only a small amount of the scavenger is needed to reduce the emissions to an acceptable level. Indeed, in testing done by applicants the formaldehyde emissions of an insulation product have been reduced to below the level of detection used to assess the formaldehyde emissions. The fibrous product thus treated contains a reaction product, formed by the reaction between the gaseous formaldehyde scavenger and free formaldehyde in the fibrous product, with the reaction product forming separate from the cured binder.

The method of the present invention is not to be limited to any particular technique for isolating or encasing the fibrous product in an enclosed space. While a rigid container, such as a tank or a box could be used, it is more convenient and less expensive to use a flexible container such as a bag. Alternatively, the fibrous product could be wrapped with a sheet or film of material to create the containing space about the fibrous product. Functionally, all that is required is to create a container volume or space in which the fibrous product is isolated, encased or inserted and suitably sealed such that a gaseous scavenger that is added or otherwise present in the space with the fibrous product is retained with little and preferably no loss of scavenger by leakage from the container volume or space. Thus, a fibrous product can be suitably isolated by encasing it in a sealed plastic film, by placing it in a plastic bag, by wrapping it with a similar packaging material, or by another similar technique. In this way, the mass transfer process that takes place as formaldehyde is emitted and captured by the commingled gaseous scavenger is optimized and/or accelerated.

The container volume or space for isolating or encasing the fibrous product can be constructed from any of a wide range of materials suitable for retaining the gaseous scavenger in the volume or space with little and preferably no loss of gaseous scavenger by leakage from the container volume or space during the time the scavenger reacts with free formaldehyde. Materials which can be suitably sealed and which themselves are inherently impervious to gaseous scavengers can be used. While normal construction materials such as a sheet metal, wood panels or gypsum board could be used, it is generally more convenient to use a film of paper, plastic or foil or some combination thereof in multiply configurations such as a metal foil-paper laminate. Plastic film wrapping, such as a polypropylene film, a polyethylene film, a polyvinyl chloride film, or a polyester film (e.g., Mylar), in sheet or bag form should generally be suitable. Indeed, one of the benefits of the present invention is that the typical way of packaging such fibrous products, and especially fiberglass insulation products, for commercial distribution using plastic packaging in sheet or bag form is easily adapted to the method of the present invention.

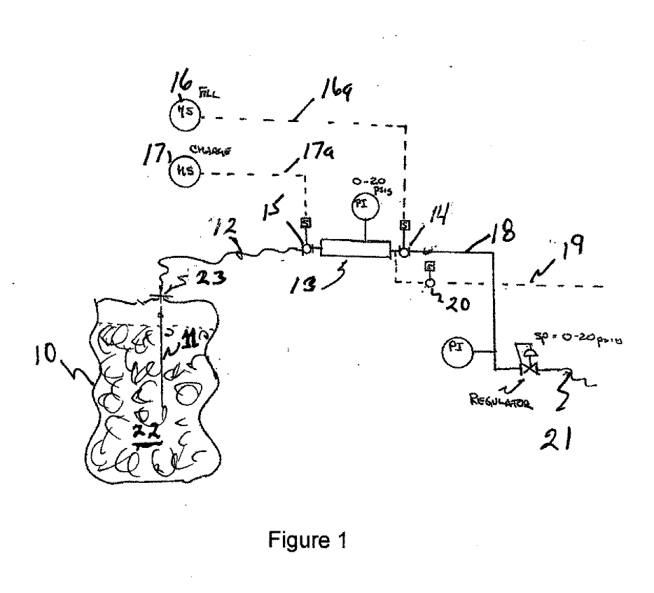

The invention will now be described with reference to the sole FIGURE, FIG. 1, which schematically illustrates one preferred method for reducing the level of formaldehyde emission from a fibrous product, such as fiberglass insulation. Again, while the invention is illustrated in connection with this specific embodiment, those skilled in the art will appreciate that the invention can be adapted for use in reducing the tendency of a fibrous product to emit formaldehyde in connection with the manufacture of a wide variety of other fibrous products that are prepared using an adhesive binder comprising a formaldehyde-containing resin. Also, the invention also can be practiced using a variety of other techniques for placing the formaldehyde scavenger and the gaseous scavenger in an enclosed space.

Illustrated schematically in FIG. 1 is one representative apparatus designed to implement the method of the present invention. As shown in FIG. 1, an enclosed space or container volume constituting bag 10 is filled with a fiberglass insulation product 22. The bag 10 has inserted into it an injection lance 11 for delivering the gaseous scavenger. Bag 10 may be made from one of a variety of plastic films such as polypropylene, polyethylene, polyvinyl chloride, polyester and the like. Lance 11 may have an opening at its end and may be provided with a tapered end to facilitate its entry into the enclosed space. Alternatively, lance 10 may have a series of openings (not shown) along its length to distribute the scavenger gas more uniformly throughout the contents of the bag. In yet another embodiment, several lances may be used, instead of a single lance as shown in the schematic drawing, in order to obtain a better distribution of the scavenger gas in and throughout bag 10. These and other such variations are within the skill of the ordinarily skilled worker.

A seal plate and gasket combination 23 ensures that the connection between the lance 11 and bag 10 is sealed, or is air-tight. Other ways of establishing a seal between the gas injector (e.g., lance 11) and the enclosed space or bag 10 will be apparent to those skilled in the art. The bag of insulation may be of a loosefill insulation of the type marketed by Guardian as Supercube II® or by Owens-Corning as Advanced ThermaCube Plus®, it also may be a roll of insulation, insulation batt, or it may take another form, such as duct board.

The injection lance 11 is connected by a gas hose 12 to a gas charge container 13. The gas charge container may simply be a suitably sized cylinder. Other arrangements for supplying a set, fixed amount of a gaseous scavenger into the enclosed space will be evident to a skilled worker. Flow of gas into and out of the gas charge container 13 is regulated in part by solenoid valves 14 and 15, whose operation is controlled by controllers 16 and 17 via control lines 16a and 17a, respectively. On the inlet side of the gas charge container 13 is gas supply tubing 18, which is connected to a gas supply source 21, such as a gas cylinder (not shown) containing the gaseous formaldehyde scavenger, such as sulfur dioxide or ammonia. Gas flow into the bag could also be accomplished using a cylinder with a plunger. The gas also could be delivered by having a plunger assembly push the gas into the bag. This and other injection methods will be evident to skilled workers.

As will be described below, the formaldehyde scavenger may be supplied as a mixture of the active scavenger gas and an inert carrier or dilution gas. An alternative gas supply line 19 is shown in shadow in FIG. 1. The gas supply line 19 is controlled by a solenoid valve 20 and a solenoid controller not shown, for supplying a source of carrier or dilution gas in the event that the gas supply of scavenger from source 21 through gas supply tubing 18 is not supplied premixed with a carrier or dilution gas.

The system operation is very straightforward. Gaseous scavenger, preferably gaseous sulfur dioxide (or a premix of gaseous sulfur dioxide and a carrier gas such as nitrogen) is supplied from a gas supply source 21, such as a pressurized gas cylinder, to the gas charge container 13 by opening the inlet solenoid valve 14 on the pressurized side of the container 13. The flow of gas into the container 13 is stopped by a preset pressure controller 16 at the pressure providing the desired quantity of the charge. At this point, the inlet valve 14 is closed. The contained gas can thereafter be charged, or injected, into the enclosed space, such as bag 10, containing the fibrous insulation product to be treated with the scavenger. This is accomplished by placing the injection lance 11 into the receptacle 10 containing the insulation product (as shown) and opening the outlet container valve 15. This allows the gas to expand into the receptacle 10 through supply tubing 12 and the lance 11. The outlet valve 15 is then closed, and the cycle repeated for subsequent injections of gaseous scavenger into additional bags of insulation.

As the injection lance is removed from a bag 10 (if provisions for securing the lance are not otherwise provided), some residual sulfur dioxide gas may escape from the lance 11 and tube 12 into the surrounding environment. If this is undesired, this result could be prevented by providing a separate fugitive gas collection system (not shown) for the lance as it is removed from the treated bag 10. Alternatively, the apparatus also could adapted to perform a separate cycle step in which an interim charge of an inert carrier gas (e.g., a short blast of compressed air or nitrogen) is provided after the charge of gaseous scavenger, in order to purge residual scavenger, e.g., sulfur dioxide, from the supply tube 12 and the lance 11 into the receiving receptacle 10. For example, this could be accomplished using supply line 19 and solenoid 20 in combination with solenoid 15, as will be recognized by a skilled worker.

Applicant has observed that implementing the method of the present invention with as little as 0.12 g sulfur dioxide per Kg of insulation has reduced the equilibrium level of formaldehyde emission from a blowing wool fiberglass product (as measured using the Dynamic Micro Chamber procedure—see the following examples) from 338 ppb to a non-detectable level. While one has a wide latitude in establishing an upper limit on the amount of the gaseous scavenger to use in the broad practice of the method of the present invention, based on considerations of safety and cost, applicant contemplates using anywhere from 0.03 g to 10.0 g of a gaseous formaldehyde scavenger, and preferably gaseous sulfur dioxide, per Kg of insulation. More preferably, applicant contemplates using from 0.06 g to 5.0 g of a gaseous formaldehyde scavenger, and preferably sulfur dioxide, per Kg of insulation. Usually, applicant expects to use from 0.08 g to 0.5 g of a gaseous formaldehyde scavenger, and preferably sulfur dioxide, per Kg of insulation. As noted above, it is convenient to introduce the formaldehyde scavenger into the enclosed space holding the fibrous product using a carrier or dilution gas. This technique provides several advantages. It facilitates delivery of a desired amount of the scavenger gas into the enclosed space and accordingly minimizes waste of the scavenger gas. It also reduces the potential safety hazard associated with any unintentional exhaust of the scavenger gas from the enclosed space.

Materials to be used in constructing the injection system schematically illustrated in FIG. 1, suitable for handling the desired scavenger gas, be it the preferred sulfur dioxide or ammonia, will be apparent to a skilled worker and need not be identified in the present application. Suffice it to say that the corrosive nature of such gases may necessitate a proper selection of materials of construction to ensure extended trouble-free operation. Such features are within the skill of the ordinarily skilled worker.

Fibrous products and especially fibrous insulation products, including those made from heat resistant fibers such as glass fibers, come in many shapes and densities. Thermal batt insulation may be unfaced or faced with a variety of materials such as Kraft paper, aluminum foil-Kraft paper or a fabric, Usually, these products have an uncompressed density of less than 50 Kg/m³. Fiber glass loosefill or blowing wool, including material such as Guardian Supercube II® loosefill insulation or Owens-Corning's Advanced ThermaCube Plus® loosefill insulation, generally have a similar uncompressed density. Even compressed, such products generally do not exhibit a density above about 300 Kg/m³. Insulation boards made from glass fibers may have a density of at least about 50 Kg/m³, and often as high as 100 Kg/m³ and higher. Other molded insulation products may have a density as high as 130 Kg/m³ and higher. Still other insulation products that can be treated in accordance with the present invention will be apparent to those skilled in the art,

The preparation of these and other insulation products, such as pipe insulation or HVAC duct insulation, or other molded insulation products made using formaldehyde-based adhesive resin binders will be understood by those skilled in the art based on this disclosure and forms no part of the present invention. The method of the present invention can be used as a way for treating all such products to reduce their level of formaldehyde emission.

Heat resistant fibrous products, including glass fiber insulation products, may also contain fibers that are not in themselves heat-resistant such as, for example, certain polyester fibers, rayon fibers, nylon fibers, cellulose fibers and super absorbent fibers, in so far as they do not materially adversely affect the performance of the fibrous product. In any event, the method of the present invention has applicability for reducing the level of formaldehyde emissions from a wide variety of fibrous products made using a formaldehyde-based adhesive resin binder.

Selection of a particular gaseous scavenger, be it sulfur dioxide or ammonia, for any particular application can generally be accomplished using routine experimentation. When using sulfur dioxide, the reaction with free formaldehyde is similar to that observed when reacting formaldehyde with a metabisulfite salt, which leads to the formation of the corresponding salt of hydroxysulfonic acid (please see Formaldehyde, Walker, J. Frederic, 3^{rd} Ed. pp. 251-253).

While not wishing to be bound by any particular theory, it is believed that the present invention maximizes the effectiveness of the gaseous scavenger for complexing with formaldehyde by injecting the gaseous formaldehyde scavenger into an enclosed space with the fibrous mat.

It will be understood that while the invention has been described in conjunction with specific embodiments thereof, the foregoing description and following examples are intended to illustrate, but not limit the scope of the invention. Other aspects, advantages and modifications will be apparent to those skilled in the art to which the invention pertains, and these aspects and modifications are within the scope of the invention. For example, the techniques of the present invention can readily be adapted, as those skilled in the art immediately appreciate from the prior description, to use in manufacturing other fibrous product such as pipe insulation designed to envelop pipe used for conveying high temperature fluids. Further, changes needed to automate the method of injecting the gaseous scavenger in connection with the packaging of a fibrous product and especially an insulation product, as described above, would be readily apparent to an ordinary skilled worker.

### EXAMPLE 1

This example illustrates an embodiment of the present invention in which a formaldehyde-emitting product, in this case a commercially available blowing wool product (Owens Corning Advanced ThermaCube Plus® blowing wool) is encased in a substantially air-tight container or package with a gaseous formaldehyde scavenger, e.g., sulfur dioxide.

A control sample was prepared by placing 135 grams of the Advanced ThermaCube Plus® (hereinafter ATC+) blowing wool into a large Ziplock® bag. The bag then was sealed tightly.

To prepare a treated sample, 135 grams of the ATC+ blowing wool also was placed into a large Ziplock® bag and then SO₂, as a gaseous formaldehyde scavenger, was filled into the bag (the intent was to replace all of the gas in the bag with SO₂) and the bag was sealed tightly.

The product formaldehyde emissions were measured in the DMC (Dynamic Micro Chamber) using the Ceq test three days after the samples were prepared. A DMC is described in Georgia-Pacific Resins, Inc. U.S. Pat. Nos. 5,286,363 and 5,395,494.

The ATC+ blowing wool samples were removed from the respective bags and placed into a wire basket that was approximately 14″×21.″ The basket had a tinfoil bottom to prevent the ATC+ blowing wool from falling through the holes in the basket. The basket was made from wire mesh with holes that were approximately ½″ wide. The basket is placed into the DMC and the Ceq test is conducted. In the Ceq test, air is circulated inside the chamber for 30 minutes with no air flow entering or exiting the chamber. After 30 minutes, the impinger of the device is hooked to the chamber and the impinger is sparged with air from the chamber for 30 minutes at a rate of 1.0 liter per minute. Air exiting the impinger is returned to the DMC. Emissions are collected using 20 mls of 0.25N NaOH in the impinger. Impinger solutions are tested for formaldehyde emissions using the standard chromotropic acid method. The results comparing the level of formaldehyde emission from the control sample to the emission form the treated sample are presented in Table 1.

TABLE 1
Product Formaldehyde Emissions Results

| | ppb |
|---|---|
| Sample | HCHO |
| Control E | 270 |
| Treated Sample E-1 | N.D. |

### EXAMPLE 2

To simulate the manufacture of fiberglass insulation, batts were prepared in the laboratory as follows. A roll of 1 inch thick, un-bonded, fiberglass was obtained from Resolute Manufacturing and divided into individual sheets weighing about 30 grams. Individual un-bonded fiberglass sheets were placed in a tray. A formaldehyde-containing binder was placed into a reservoir and air was used to aspirate the binder into a fine mist. The mist was drawn through each individual batt using an air exhaust hood. This technique caused fine binder droplets to be deposited onto and into the batt. Approximately eight grams of binder was deposited onto each sample of the glass batt. Following binder application, the batts were cured in a forced air oven for two minutes at 425° F. (218° C.) to cure the binder. After curing, one batt was treated with ammonia by breaking ammonia smelling salt inside a Ziplock®-type storage bag which was immediately sealed, the other sample was transferred to another Ziplock®-type storage bag without any treatment until both sample could be tested using a consistent technique in a dynamic micro chamber (DMC) to test its formaldehyde emission characteristic.

The average results reported as the ppb formaldehyde are reported in Table 2 below. As shown, the method of the present invention resulted in a significant reduction in formaldehyde emission compared with the Control Example.

TABLE 2
Formaldehyde Emission Results
(ppb Formaldehyde)

| EXPERIMENT | Control | Ammonia |
|---|---|---|
| Average | 94.8 | 46.1 |
| % Reduction | — | 51.4 |
| from Control | | |

### EXAMPLE 3

This example illustrates another embodiment of the present invention in which a formaldehyde-emitting product, in this case a commercially available blowing wool product (Owens Corning Advanced Thermacube Plus® blowing wool) is encased in a substantially air-tight container or package with a gaseous formaldehyde scavenger, e.g., sulfur dioxide.

A control sample was prepared by placing 135 grams of the Advanced ThermaCube Plus® (hereinafter ATC+) blowing wool into a 1 L nalgene bottle and sealed.

Treated samples were prepared by also putting 135 grams of ATC+ blowing wool into a 1 L nalgene bottle. Sulfur dioxide (120 cubic centimeters STP) was injected into the bottom of the bottle using a hypodermic needle and the bottle was sealed. Three concentrations of sulfur dioxide were used, pure (100%), 10% (by volume in nitrogen) and 1% (by volume in nitrogen).

The product formaldehyde emissions were measured four (4) days later in the DMC (Dynamic Micro Chamber) using the Ceq test. The ATC+ blowing wool samples were removed from the respective bottles and placed into a wire basket that was approximately 14″×21.″ The basket had a tinfoil bottom to prevent the ATC+ blowing wool from falling through the holes in the basket. The basket was made from wire mesh with holes that were approximately ½″ wide. The basket is placed into the DMC and the Ceq test is conducted. In the Ceq test, air is circulated inside the chamber for 30 minutes with no air flow entering or exiting the chamber. After 30 minutes, the impinger of the device is hooked to the chamber and the impinger is sparged with air from the chamber for 30 minutes at a rate of 1.0 liter per minute. Air exiting the impinger is returned to the DMC. Emissions are collected using 20 mls of 0.25N NaOH in the impinger. Impinger solutions are tested for formaldehyde emissions using the standard chromotropic acid method. The results comparing the level of formaldehyde emission from the control sample to the emission form the treated samples are presented in Table 3.

TABLE 3
Product Formaldehyde Emissions Results

| | ppb |
|---|---|
| Sample | HCHO |
| Control | 338 |
| 100% SO₂ - 120 ccs | N.D. |
| 10% SO₂ - 120 ccs | ND |
| 1% SO₂ - 120 ccs | 254 |

### EXAMPLE 4

The procedure of Example 3 was repeated. However, in this case the treated samples were prepared by injecting a gas containing 10% by volume sulfur dioxide in nitrogen into the bottom of the nalgene bottle using a hypodermic needle and the bottle was sealed. Four (4) treated samples were prepared using 5, 10, 20 and 40 cubic centimeters (STP) of the gas for the respective treatments. The DMC Ceq results comparing the level of formaldehyde emission from the control sample to the emission form the treated samples are presented in Table 4.

TABLE 4
Product Formaldehyde Emissions Results

| | ppb |
|---|---|
| Sample | HCHO |
| Control | 150 |
| 10% SO₂ - 5 ccs | 232 |
| 10% SO₂ - 10 ccs | 173 |
| 10% SO₂ - 20 ccs | 91 |
| 10% SO₂ - 40 ccs | 35 |

The present invention has been described with reference to specific embodiments. However, this application is intended to cover those changes and substitutions that may be made by those skilled in the art without departing from the spirit and the scope of the invention. Unless otherwise specifically indicated, all percentages are by weight. Throughout the specification and in the claims the term “about” is intended to encompass + or −5%.

1. A method for reducing formaldehyde emission from a fiberglass insulation product comprising a formaldehyde-containing resin, the method comprising isolating the fiberglass insulation product in an enclosed space, introducing a gaseous formaldehyde scavenger into the space and maintaining the gaseous scavenger in the space for a time sufficient to reduce the level of formaldehyde emission.

2. The method of claim 1 wherein the fiberglass insulation product is wrapped with a film of material to produce the enclosed space.

3. The method of claim 1 wherein the fiberglass insulation product is placed into a bag and the bag is then sealed to produce the enclosed space.

4. The method of claim 1, 2 or 3 wherein the gaseous formaldehyde scavenger is selected from the group consisting of ammonia and sulfur dioxide.

5. The method of claim 3 wherein the gaseous formaldehyde scavenger is sulfur dioxide.

6. The method of claim 3 wherein the bag comprises a plastic.

7. The method of claim 5 wherein the bag comprises a plastic.

8. The method of claim 2 wherein the film of material comprises a plastic.

9. The method of claim 1 wherein an amount of the gaseous formaldehyde scavenger between 0.03 g to 10.0 g per 1 Kg of the fibrous product is introduced into the enclosed space.

10. The method of claim 7 wherein an amount of the gaseous formaldehyde scavenger between 0.03 g to 10.0 g per 1 Kg of the fibrous product is introduced into the enclosed space.

11. The method of claim 1 wherein an amount of the gaseous formaldehyde scavenger between 0.06 g to 5.0 g per 1 Kg of the fibrous product is introduced into the enclosed space.

12. The method of claim 7 wherein an amount of the gaseous formaldehyde scavenger between 0.06 g to 5.0 g per 1 Kg of the fibrous product is introduced into the enclosed space.

13. A fibrous mat produced by the method of claim 1.

14. The method of claim 1 wherein the gaseous formaldehyde scavenger is sulfur dioxide.

15. A method for reducing formaldehyde emission from a fibrous product comprising a formaldehyde-containing resin, the method comprising isolating the fibrous product in an enclosed space, introducing a gaseous formaldehyde scavenger into the space and maintaining the gaseous scavenger in the space for a time sufficient to reduce the level of formaldehyde emission, where the fibrous product is placed into a bag and the bag is then sealed to produce the enclosed space.

16. A method for reducing formaldehyde emission from a fibrous product comprising a formaldehyde-containing resin, the method comprising isolating the fibrous product having a density less than 160 Kg/m³ in an enclosed space, introducing a gaseous formaldehyde scavenger into the space and maintaining the gaseous scavenger in the space for a time sufficient to reduce the level of formaldehyde emission

17. The method of claim 16 wherein the fibrous product is placed into a bag and the bag is then sealed to produce the enclosed space.

18. The method of claim 16 wherein the gaseous formaldehyde scavenger is sulfur dioxide.

19. The method of claim 16 wherein an amount of the gaseous formaldehyde scavenger between 0.03 g to 10.0 g per 1 Kg of the fibrous product is introduced into the enclosed space.

20. The method of claim 16 wherein an amount of the gaseous formaldehyde scavenger between 0.06 g to 5.0 g per 1 Kg of the fibrous product is introduced into the enclosed space.
